(19) United States
(12) Patent Application Publication
(10) Pub. No.: US 2008/0302248 A1
(43) Pub. Date: Dec. 11, 2008

(54) Structure of Hot Beverage Machine Using Steam Pressure to Seal Feeder

(76) Inventor: Yu-Yuan Lin, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/758,130

(22) Filed: Jun. 5, 2007

(51) Int. Cl. A47J 31/44; A47J 31/30

(52) U.S. Cl. 99/289 R

(57) ABSTRACT

A structure of a hot beverage machine using steam pressure is provided to seal a feeder for various drinks placed with raw materials, such as coffee powder, coffee bag, tea leaves, tea bags, etc., and utilized with a sealing element, which allows steam to come in. When the machine is used, the feeder is tightly sealed with the sealing element so as to make drinks with purer flavor. Alternatively, when the machine is not in use for brewing, the feeder is separated from the sealing element with a distance such that the hot beverage machine can have a variety of different functions.

### FIELD OF THE INVENTION

The present invention relates to hot beverage machines, particularly relates to a structure of a hot beverage machine using steam pressure to seal a feeder for various drinks placed with raw materials, such as coffee powder, coffee bag, tea leaves, tea bags, etc., and utilized with a sealing element, which allows steam to come in. When the machine is used, the feeder is tightly sealed with the sealing element so as to make drinks with purer flavor. Alternatively, when the machine is not in use for brewing, the feeder is separated from the sealing element with a distance such that the hot beverage machine can have a variety of different functions.

### BACKGROUND OF THE INVENTION

A variety of hot beverage machines with various shapes and forms exist in the market. One type of the hot beverage machines heats up water and then brews raw material of the drink placed within the hot beverage machine by dripping hot water thereon. However, no sealing separation exists between the feeder thereof and the outside, causing high temperature steam to easily escape to the surrounding area when the drink is brewed. As a result, the raw material of the drink cannot be completely brewed by high temperature with the flavor sealed in. Consequently, the hot beverage brewed lacks of pure flavor.

### SUMMARY OF THE INVENTION

The present invention improves conventional designs of hot beverage machines where a variety of drinks are made by heating steam to brew the raw material placed in an open position; as a result, the flavor generated cannot be as pure as expected. The purpose of the improvement is to brew beverages with purer flavor by tightly sealing a feeder of a hot beverage machine by a sealing element with easy operation.

One object of the present invention is to provide a guiding member having sloping grooves on an outer surface and an inner rim for supporting said feeder placed in said supporting base. The sloping grooves of said guiding member receive a plurality of protrusions on the inner surface of a shifting member. A stopping portion extending from one side of an inner edge of said shifting member has a concave opening. A shifter extending outwardly from said shifting member is protruded from and restricted by a groove of said supporting base when assembled. Wherein beverage material is placed in said feeder when brewing a beverage, the guiding member is moved upward along with the feeder by moving the shifter of the shifting member to one side so as to form a tight seal between the feeder and the sealing element engaged at the bottom of the connecting member.

Another object of the present invention is to provide a top cover with a plurality of supporting portions extending downward. The top cover is disposed on top of the shifting member and has a plurality of engaging portions protruded from the bottom matching with the top of a joining member disposed on a connecting member connecting with a steam tube. The top cover, the joining member and the connecting member are then combined together by screwing elements. A sealing element with high temperature resistance is tightly engaged with a bottom rim groove of the connecting member so as to clamp a steam filter net there between. A steam tube passing through the connecting member contains a flexible contacting element with resist high temperature resistance and a positioning lever adjacent to the contacting element and connects with a boundary element with a through hole such that the positioning lever contained therein is movable. The steam tube of the connecting member pushes the contacting element therein outward after the steam comes in, such that the adjacent positioning lever is protruded from the through hole of the boundary element, so as to correspondingly engage to the opening of the stopping portion of the shifting member and to form a tight seal with the sealing element engaged at the bottom of the connecting member connecting the steam tube, and thus make the brewed coffee and tea purer and denser.

### BRIEF DESCRIPTION OF THE DRAWINGS

FIG. 1 is an exploded perspective view of a steam sealing device of a hot beverage machine in accordance with the present invention.

FIG. 2 is a schematic view of the hot beverage machine combined with the steam sealing device in accordance with the present invention.

FIG. 3 is a schematic view of a shifting member of the steam sealing device of the hot beverage machine before movement in accordance with the present invention.

FIG. 4 is a top view of the shifting member of the steam sealing device of the hot beverage machine before movement in accordance with the present invention.

FIG. 5 is a detailed cross-sectional view taken along line 50-50 in FIG.4.

FIG. 6 is a schematic view of the shifting member of the steam sealing device of the hot beverage machine after movement in accordance with the present invention.

FIG. 7 is a top view of the shifting member of the steam sealing device of the hot beverage machine after movement in accordance with the present invention.

FIG. 8 is a detailed cross-sectional view taken along line 80-80 in FIG.7.

FIG. 9 is a schematic view of an engagement of a positioning lever and an opening of the shifting member after stem enters into a steam tube so as to push the positioning lever to move toward the opening.

### DETAILED DESCRIPTION OF THE EMBODIMENTS

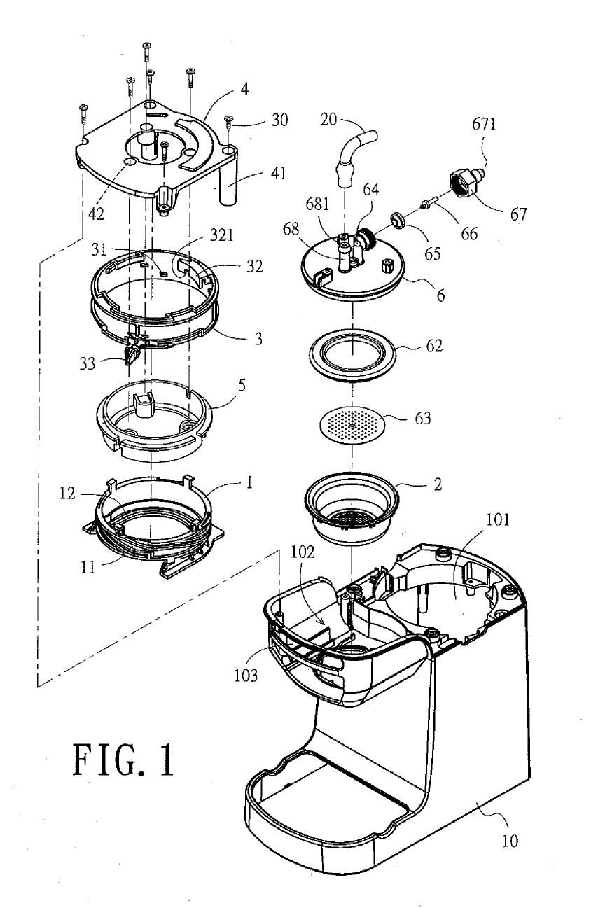

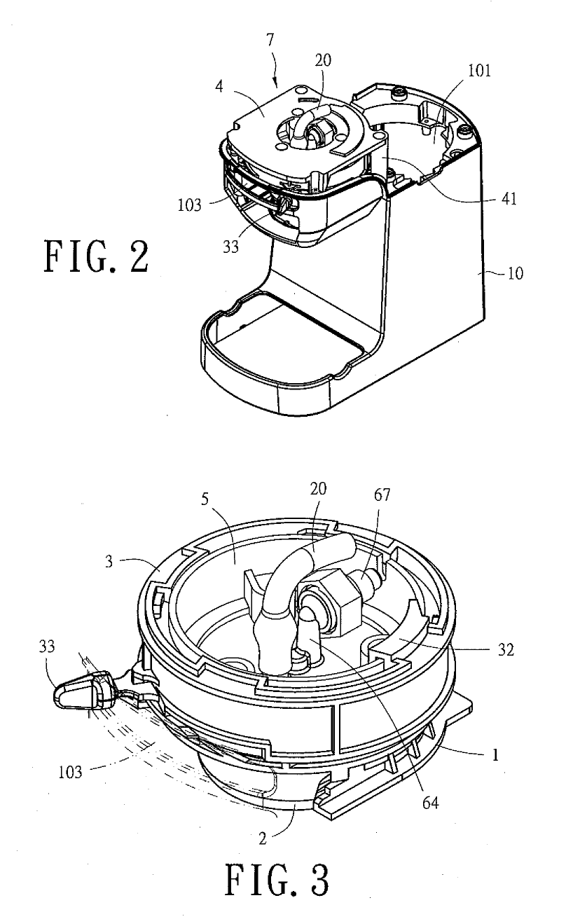

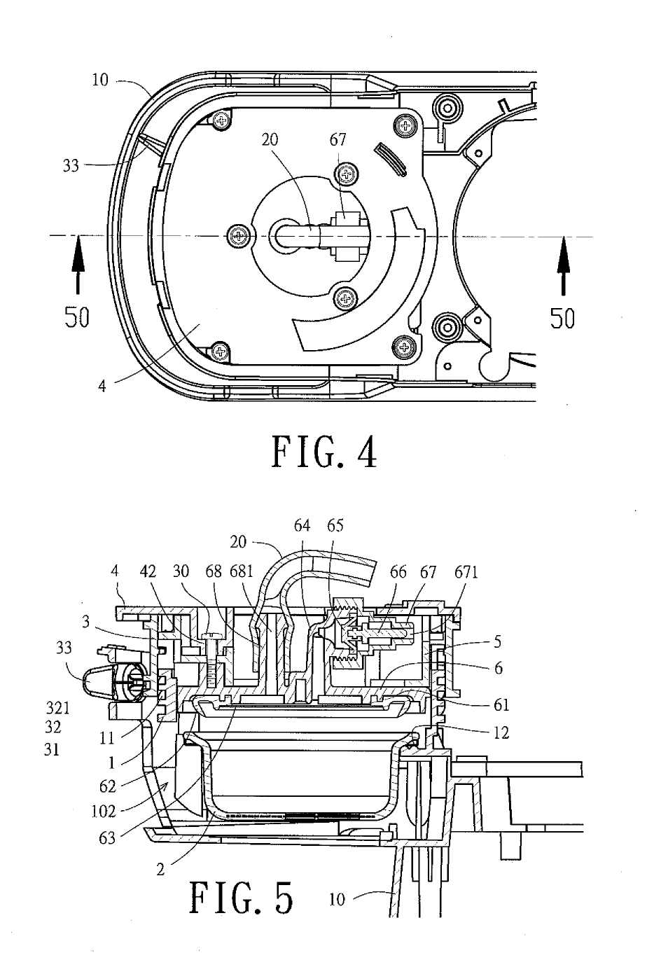

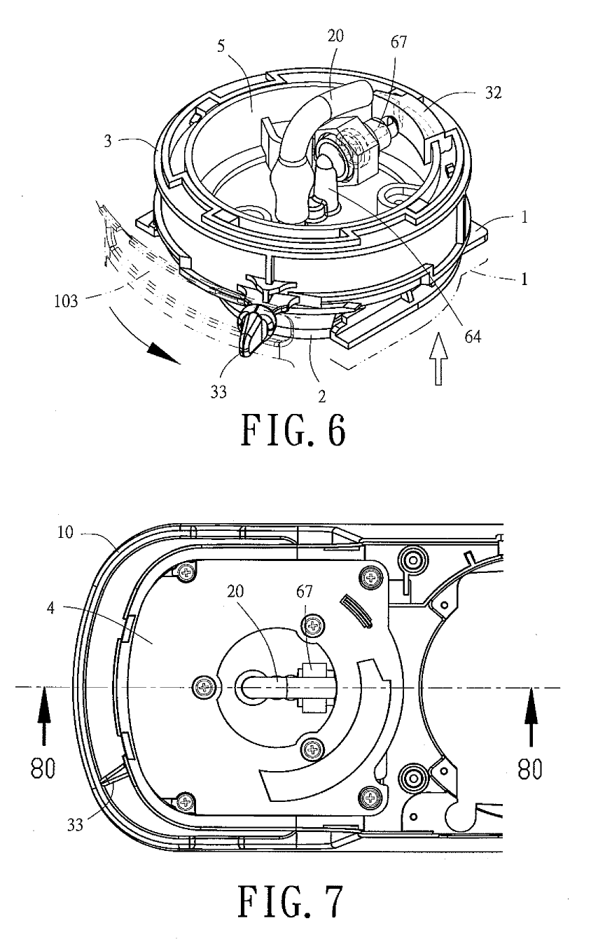

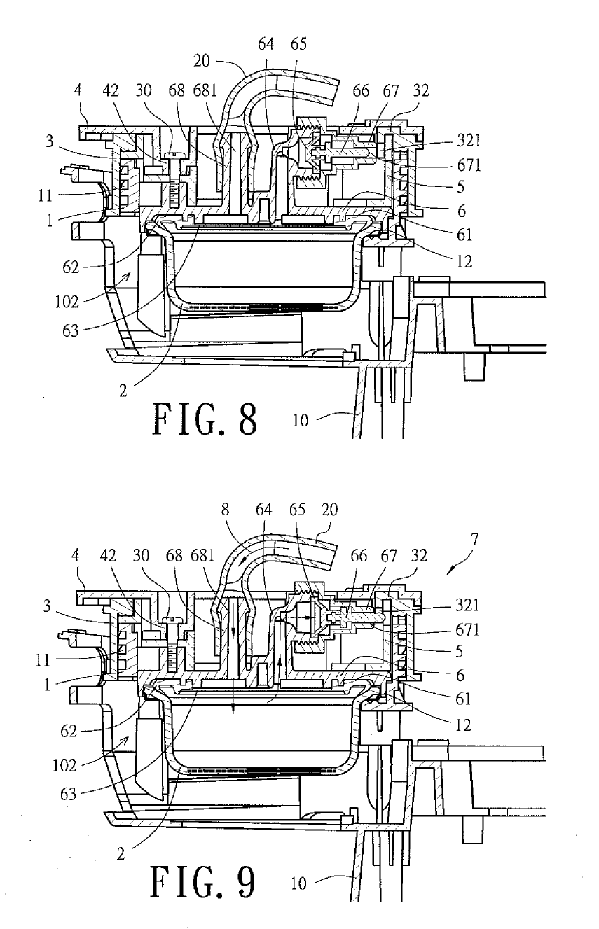

Referring to FIGS. 1 and 5, a structure of a hot beverage machine 10 using steam pressure to seal a feeder in accordance with the present invention is illustrated, wherein a steam sealing device 7 is assembled with a supporting base 102 formed at a front brewing area of a water container 101 placed in the hack of the hot beverage machine 10. The steam sealing device 7 is described in details hereinafter. The steam sealing device 7 comprises in sequence a guiding member 1 placed in the supporting base 102, a feeder 2, a shifting member 3, a top cover 4, a joining member 5, and a connecting member 6. The guiding member 1 has sloping grooves 11 on an outer surface and an inner rim 12 on an inner surface. The inner rim 12 allows the feeder 2 to rest thereon, while the sloping groove 1 1 allows protrusions 31 of a shifting member 3 to be received therein. One side of an inner edge of the shifting member 3 is formed with a stopping portion 32 provided with a concave opening 321. A shifter 33 extending outwardly from the shifting member 3 is projected from and restricted by a groove 103 corresponding to the supporting base 102 when assembled, as shown in FIG. 2. The top cover 4 with a plurality of supporting portions 41 extending downward is disposed on top of the shifting member 3 and has a plurality of engaging portions 42 protruded from the bottom matching with the top of the joining member 5 disposed on the connecting member 6 connecting with a steam tube 20. The top cover 4, the joining member 5 and the connecting member 6 are then combined together by screwing elements 30. A sealing element 62 with high temperature resistance is tightly engaged with a bottom rim groove 61 of the connecting member 6, as shown in FIG. 5, so as to clamp a steam filter net 63 there between. A steam tube 64 passing through the connecting member 6 contains a flexible contacting element 65 with resist high temperature resistance therein and a positioning lever 66 adjacent to the contacting element 65. A boundary element 67 with a through hole 671 is connected with an opening end of the steam tube 64 such that the positioning lever 66 contained therein is movable. A connecting pipe 68 with a through hole 681 extending upward from the connecting member 6 can be tightly connected with the steam pipe 20. Referring to FIGS. 3-5, for brewing a beverage, beverage material is placed in the feeder 2. Referring to FIGS. 6 and 7, the protruding shifter 33 of the shifting member 3 is then moved toward one side so as to cause the guiding member 1 to move upward. The feeder 2 crossed over the guiding member 1 will accordingly move upward, as shown in FIG. 8, so as to form a sealed position with the sealing element 62 engaged at the bottom of the connecting member 6. After steam 8 comes into the steam tube 64 of the connecting member 6, the flexible supporting element 65 therein is pushed outward such that the adjacent positioning lever 67 is protruded from the through hole 671 of the boundary element 67, as shown in FIG. 9, and correspondingly engage to the opening 321 of the stopping portion 32 of the shifting member 3, so as to form positional restriction to the movement of the shifting member 3. As shown in FIG. 9, when brewing a beverage with the steam sealing device 7 of the supporting base 102 in the front of the hot beverage machine 10, the shifter 3 can be used to move the feeder 2 upward and the guiding member 1 will move upward simultaneously, such that a tight seal is formed between the feed 2 and the sealing element 62 engaged at the bottom of the connecting member 6 connecting to the steam tube 20, thereby brewing coffee by steam with better density.

The above assembly having the steam sealing device provided in the supporting based in the front of the hot beverage machine has the following advantages when brewing a variety of drinks:

1. When brewing a beverage by the hot beverage machine assembled with a steam sealing device therein, the guiding member is moved upward along with the feeder by moving the shifter of the shifting member to one side, so as to form a tight seal between the feeder and the sealing element engaged at the bottom of the connecting member. As a result, the beverage material placed in the feeder can be sealed and brewed completely with steam.

2. When a seal status is formed in the steam sealing device, the steam tube of the connecting member can push the contacting element therein outward after the steam comes in, such that the adjacent positioning lever is protruded from the through hole of the boundary element, so as to correspondingly engage to the opening of the stopping portion of the shifting member and form a positional restriction to the movement of the shifting member.

3. The shifting member of the steam sealing device is used to move the guiding member so as to drive the feeder there between to move upward. Tight seal is formed between the feeder and the sealing element engaged at the bottom of the connecting member connecting the steam tube, and thus steam will not escape and will make the brewed coffee and tea purer and denser.

What is claimed is:

1. A structure using steam pressure to seal a feeder of a hot beverage machine comprises a steam sealing device provided in a supporting base in a brewing area in front of a water container disposed in the back of said hot beverage machine, characterized in that
a guiding member having sloping grooves on an outer surface and an inner rim for supporting said feeder is placed in said supporting base, said sloping grooves of said guiding member receive a plurality of protrusions on an inner surface of a shifting member, a stopping portion extending from one side of an inner edge of said shifting member has a concave opening, a shifter extending outwardly from said shifting member is protruded from and restricted by a groove of said supporting base when assembled, a top cover with a plurality of supporting portions extending downward is disposed on top of the shifting member and has a plurality of engaging portions protruded from the bottom matching with the top of a joining member disposed on a connecting member connecting with a steam tube so as to combined the top cover, the joining member and the connecting member together by screwing elements, a sealing element with high temperature resistance is tightly engaged with a bottom rim groove of the connecting member so as to clamp a steam filter net there between, and a steam tube passing through the connecting member contains a flexible contacting element with resist high temperature resistance and a positioning lever adjacent to the contacting element and connects with a boundary element with a through hole such that the positioning lever contained therein is movable;
wherein beverage material is placed in said feeder when brewing a beverage, the guiding member is moved upward along with the feeder by moving the shifter of the shifting member to one side so as to form a tight seal between the feeder and the sealing element engaged at the bottom of the connecting member; and
wherein the steam tube of the connecting member pushes the contacting element therein outward after the steam comes in, such that the adjacent positioning lever is protruded from the through hole of the boundary element, so as to correspondingly engage to the opening of the stopping portion of the shifting member and form a positional restriction to the movement of the shifting member.

2. A structure using steam pressure to seal a feeder of a hot beverage machine comprises a steam sealing device provided in a supporting base in a brewing area in the front of said hot beverage machine, wherein said steam sealing device comprises a guiding member and a feeder supported by an inner rim of the guiding member, an outer surface the guiding member matches a shifting member having a plurality of protrusions on its inner surface, and a top cover with a plurality of supporting portions extending downward is disposed on top of the shifting member and has a plurality of engaging portions protruded from the bottom for correspondingly leaning against a joining member and assembling with a connecting member connecting with a steam tube;
wherein when brewing a beverage with said steam sealing device assembled in said supporting base, the shifting member is shifted to move the guiding structure upward as well as to move the feeder therein upward so as to form a tight seal with said sealing element engaged at the bottom of said connecting member, thereby utilizing steam to brew coffee or tea purer and denser.
